(19) United States
(12) Patent Application Publication
(10) Pub. No.: US 2015/0310242 A1
(43) Pub. Date: Oct. 29, 2015

(54) CAMERA AND METHOD FOR THE DETECTION OF A MOVED FLOW OF OBJECTS

(71) Applicant: SICK AG, Waldkirch (DE)

(72) Inventor: Klemens WEHRLE, Waldkirch (DE)

(21) Appl. No.: 14/693,209

(22) Filed: Apr. 22, 2015

(30) Foreign Application Priority Data
Apr. 24, 2014 (DE) 10 2014 105 759.7

(51) Int. Cl. G06K 7/10

(52) U.S. Cl. CPC G06K 7/10762; G06K 7/10732; G06K 7/10801; G06K 7/10811

(57) ABSTRACT

A camera is provided for the detection of a flow of objects moved relative to the camera, comprising an image sensor for the taking of images of the objects and a receiving optics that is arranged in front of the image sensor and that has a depth of field range. In this respect, a mirror unit having at least two mirror elements is arranged in front of the receiving optics, the mirror elements having a different spacing amongst one another with respect to the receiving optics and/or having a different tilt angle and in this way imaging sections of the object flow a plurality of times with light paths of different length and in this way with different depth of field ranges at the image sensor.

The invention relates to a camera for the detection of a flow of objects moved relative to the camera, comprising an image sensor for the taking of images of the objects and a receiving optics arranged in front of the image sensor, the receiving optics having a depth of field range and to a method for the detection of a moved flow of objects, in which images of the objects are taken by a receiving optics having a depth of field range.

Cameras are used in a plethora of ways in industrial applications in order to automatically detect object properties, for example, for the inspection or the measurement of objects. In this respect images of the objects are taken and are evaluated by means of image processing methods in accordance with a corresponding task. A further application of cameras is the reading of codes. Such camera-based code readers are increasingly replacing the still widely used barcode scanner. Objects with codes present thereon are recorded with the aid of an image sensor, with the code regions being identified in the images and then being decoded. Camera-based code readers can also be used with different kinds of code other than one-dimensional barcodes, the different kinds of code being assembled like a matrix code also in two dimensions and making available more information. Typical fields of application of code readers are supermarket cash desks, automatic package identification, sorting of post, luggage handling in airports and further logistical applications.

One frequent situation of detection is the mounting of the camera above a conveyor belt. During the relative movement of the object flow at the conveyor belt, the camera takes images and in dependence on the obtained object properties induces further processing steps. Such processing steps, for example, comprise a further processing adapted to the specific object at a machine, the machine interacting with the conveyed object, or with a change of the object flow in that certain objects are excluded from the object flow in the frame work of a quality control or the object flow is sorted into a plurality of part object flows. When the camera is a camera-based code reader the objects are identified with reference to the attached codes for a correct sorting or for similar processing steps. As a rule the conveyor system provides impulses in a continuous manner, with the impulses being related to the path and being provided by means of an incremental signal generator, in this way the object positions are known at every point in time also during alternating conveyor speeds.

In order to read codes or to carry out other evaluations of the images, the images should be sufficiently focused. This represents a challenge, as the object distance varies considerably due to different object heights. The depth of field of the camera lens is frequently not sufficient to cover the overall required range. For this reason it is common to track a variable focus setting for this purpose in the camera, with the variable focus corresponding to the object distance. This in turn not only means a high demand in effort and cost, but also does not solve this problem in a satisfying way, when a plurality of objects of significantly different height should be detected at the same time. The camera can then at best be set to one of the required focus positions. Thus, images of reduced quality arise and no reads of codes can occur for objects outside of the limited depth of field range. This situation is particularly frequently present having regard to wider conveyor belts or for a plurality of conveyor belts arranged next to one another. Moreover, only a relatively small detection range remains for a focus adjustment onto a high object.

A common approach, for example in accordance with DE 102 07 538 A1 or EP 2 693 363 A1 consists therein of using a plurality of detection units and to ensure that each object is detected in a focused manner by at least one detection unit by means of a cooperative focus strategy. However, this leads to a considerable additional demand in effort and cost having regard to the further detection unit.

The EP 1 931 133 A1 utilizes different embodiments of an optics in order to image a structure at an image recorder a plurality of times in regions separated from one another and spaced apart from one another. However, this does not serve the purpose of reading of codes nor of a different focusing.

In the DE 20 2013 009 198 U1 a system for the expansion of a viewing field of a camera is disclosed that is based on a module having two mirrors attached thereto. Thereby, an expanded viewing field is imaged strip-wise above one another at the image sensor. The EP 2 624 042 A2 shows s mirror attachment having a construction more demanding in effort and cost and that comprises four mirrors for a similar expansion of the viewing field. In both cases, however, a correct focusing of the receiving optics is still a pre-requisite.

For this reason it is an object of the invention to achieve an improved detection of objects moved in a flow.

This object is satisfied by a camera that is characterized by a mirror unit having at least two mirror elements, with the mirror unit being arranged in front of the receiving optics, the mirror elements having a different spacing amongst one another with respect to the receiving optics and/or having a different tilt angle and in this way imaging sections of the object flow a plurality of times with light paths of different length and in this way with different depth of field ranges at the image sensor.

The object is further satisfied by a method for the detection of a moved flow of objects in which the taking takes place via a mirror unit having at least two mirror elements that have a different spacing amongst one another with respect to the receiving optics and/or having a different tilt angle and in this way imaging sections of the object flow a plurality of times with light paths of different length and in this way with different depth of field ranges.

In this respect the invention is based on the basic idea of imaging sections of the object flow at an image sensor a plurality of times through a receiving optics and in this respect to fold the respective light path in different ways with a mirror unit having at least two mirror elements.

The multiple imaging is associated in this respect with a double meaning. On the one hand, the image sensor is used a plurality of times. A part of the available surface of the image sensor is surrendered in order to image a plurality of sections of the object flow at the same time at the image sensor, in particular above one another. On the other hand, sections of the object flow are imaged a plurality of times and indeed because of the mirror elements with different light paths. The variation of the length of the light path by means of the plurality of mirror elements leads to different object distances. Having regard to at least one image of a section, thus an object distance matched to the depth of field range of the receiving object results and in this way a focused image results.

It is indeed plausible that the same section is imaged at the same time with light paths of different length a plurality of times at the image sensor by means of suitable distance stagger and tilts of the mirror elements. However, this is not required. Likewise it is plausible to provide a significant displacement of the sections in the object flow by tilting the mirror elements in such a way that a section is only recorded again in a latter image. Thus, for example, a section is detected initially in an earlier position having a large object distance and one further time in a latter position having a smaller object distance. The displacement can be compensated without further ado when the intermittent object movement is detected through the knowledge of a constant conveying speed or with the aid of a known additional feed sensor.

The invention has the advantage that focused images of objects with significantly different objects heights can be recorded without the use of additional image sensors or an adjustable focus unit. The depth of field range is enlarged by a multiple imaging at light paths of different length or at different object distances respectively. The surface of the image sensor—that is frequently at least approximately quadratic—is in anyway not necessarily required in its longitudinal direction corresponding to the movement direction of the objects, since only redundant image information would in any way be detected for sufficiently high recording frequencies. The height direction is used in an improved manner and the complete object flow remains detectable also with the flatter viewing field of the segments by means of the division of the quadratic viewing field into segments. The redundancy is in this respect advantageously used for the purpose of recording the sections at light paths of different length and in this way for recording each section at least once in an as focused a manner as possible. Through the folded light paths also the problem of dynamic focus adjustments of too small a viewing field for high objects is solved (“Christmas tree effect”).

The camera preferably has a selection unit in order to respectively select an image section of largest image focus. The sections are redundantly recorded respectively once per mirror element. According to this, a light path is present by means of which the section of a distance spacing matching the receiving optics or in any event matching the object spacing best is recorded. The selection unit determines the image focus, for example, by means of a contrast value formed via the pixels of the recording of the sections and respectively selects that recording of the section for subsequent processing steps which has the largest image focus. In as far as the images are used for the decoding of codes or OCR (Optical Character Recognition) the selection can consist therein in attempting a decoding or sign recognition with all of the sections.

The camera is preferably configured as a camera-based code reader having a decoding unit for the identification of code regions and for the reading of code content. The decoding has a particularly high reading rate, as the codes are recorded with different object distances and thereby are recorded at least once at least approximately focused.

The camera preferably has an illumination unit whose light is deflected via the mirror elements into the respective sections in order to illuminate these. The illumination thus utilizes the same mirror elements like the receiving light. Thereby the sections are illuminated without anything having to be changed at the illumination unit with respect to a common illumination. In this respect even a possible focusing of the illumination in at least one section is correctly adapted in accordance with the same mechanism like is used for the depth of field range of the receiving optics, and indeed in that section that is already recorded in a focused manner provided the illumination and the receiving optics are adapted with respect to one another.

The mirror elements are preferably arranged staggered one after the other or staggered above one another. In this respect one after the other means a multiple arrangement, at least approximately in the movement direction of the objects, and above one another means in a direction perpendicular thereto. The staggered mirror elements form a kind of staircase with a light path of increasing length. They are preferably nearly all arranged in parallel with respect to one another such that the detected sections of the object flow lie next to one another. In a preferred embodiment the staggered mirror elements are tilted slightly with respect to one another because in this way even those sections can be detected at the same time with light paths of different length and can be imaged in a plurality of segments at the image sensor.

The mirror elements are preferably tilted with respect to one another in such a way that they detect object surfaces of different orientation from sections spaced apart with respect to one another. In this respect the tilt and not, as is the case for a staggered arrangement, the spacing of the mirror elements thus ensures the light paths of different length. A section is only recorded again in this example with a displacement in time. Depending on the object geometry it can also occur that a section is not even detected a plurality of times due to the tilt; however, it can in any way be ensured that the concerned object region was detected at least once. An example for this purpose is the simultaneous recording of the rear side of an object that has already passed the camera, the upper side of an object beneath the camera and the front side of an object still to be moved towards the camera.

The mirror elements are preferably divided into at least two mirror sub-segments that are tilted with respect to one another in order to image part sections lying next to one another in a width direction, above one another at the image sensor. This embodiment combines the multiple recording in accordance with the invention at light paths of different length with a viewing field expansion as it is known from the DE 20 2013 009 198 U1 named in the introduction. The mirror sub-segments are thus tilted with respect to one another in the longitudinal direction and/or the transverse direction in order to detect segments of the sections lying next to one another. Each mirror element can in this respect be configured in all variants that are described in the DE 20 2013 009 198 U1. Alternatively, a plurality of cameras can be utilized next to one another for the detection of a wide object flow. In both cases it is advantageously possible to connect the segments of the sections to one another (image stitching) by means of an image processing, be it by means of the detection via mirror sub-segments or by means of a plurality of cameras.

The camera is preferably mounted in a stationary manner at a conveying apparatus for objects provided with codes, the objects forming the flow of objects. This a particularly frequent case of application in that a focused detection of the codes at differently high objects is important for an improved reading rate.

The camera is preferably oriented away from the moved flow. Expressed in a very technical manner the optical axis of the receiving optics is arranged approximately perpendicular to the movement direction of the objects and arranged facing away from the objects. This can be understood in an improved manner having regard to the case of application as a camera that is mounted above a conveying apparatus and in accordance with this embodiment is substantially oriented upwardly. The mirror unit in this embodiment ensures a deflection at the order of magnitude of 180° by means of which variations of 20°-40° should also be covered.

In a different preferred embodiment the camera is oriented in parallel to the moved flow. In this example the optical axis of the receiving optics points in the movement direction of the objects or against this movement direction. The mirror unit in this respect ensures for a deflection of the order of magnitude of 90°. In this respect the statement of angles is not defined, at least not to 10°.

The method in accordance with the invention can be adapted in a similar manner and in this respect shows similar advantages. Such advantageous features are described by way of example, but not conclusively in the subordinate claims adjoining the independent claims.

The invention will be described in detail in the following also with regard to further features and advantages by way of example by means of embodiments and with reference to the submitted drawing. The images of the drawing show in:

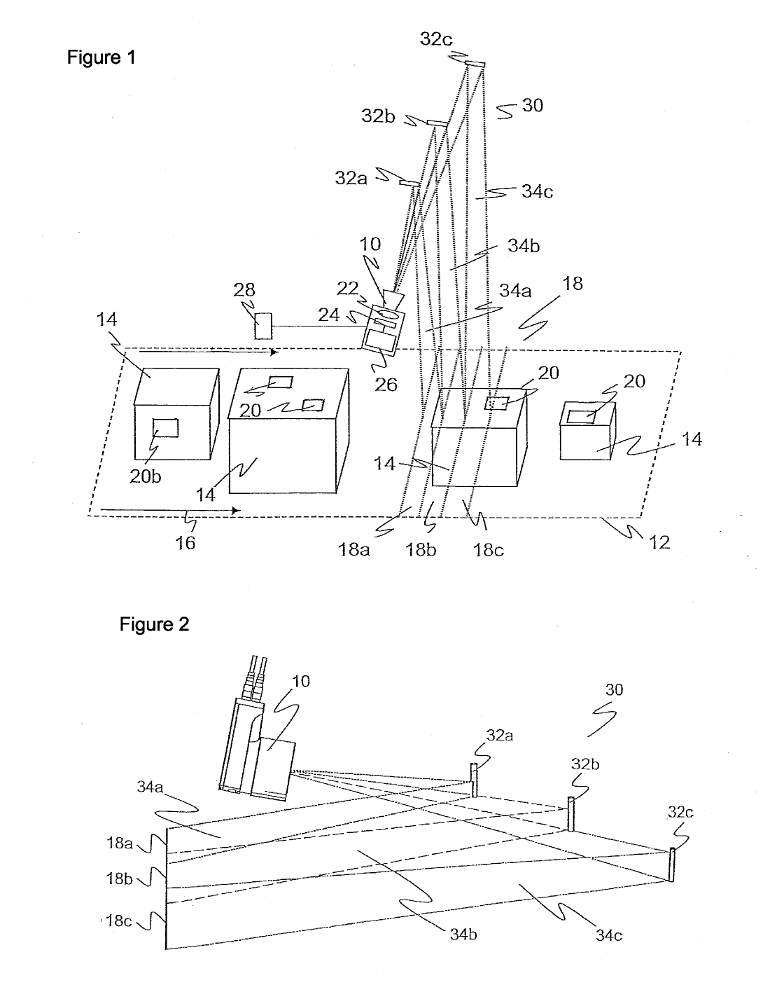

FIG. 1 a schematic three-dimensional view of a camera mounted at a conveyor belt with objects carrying the codes to be detected;

FIG. 2 an enlarged illustration of a camera and its viewing field segmented by means of a mirror unit;

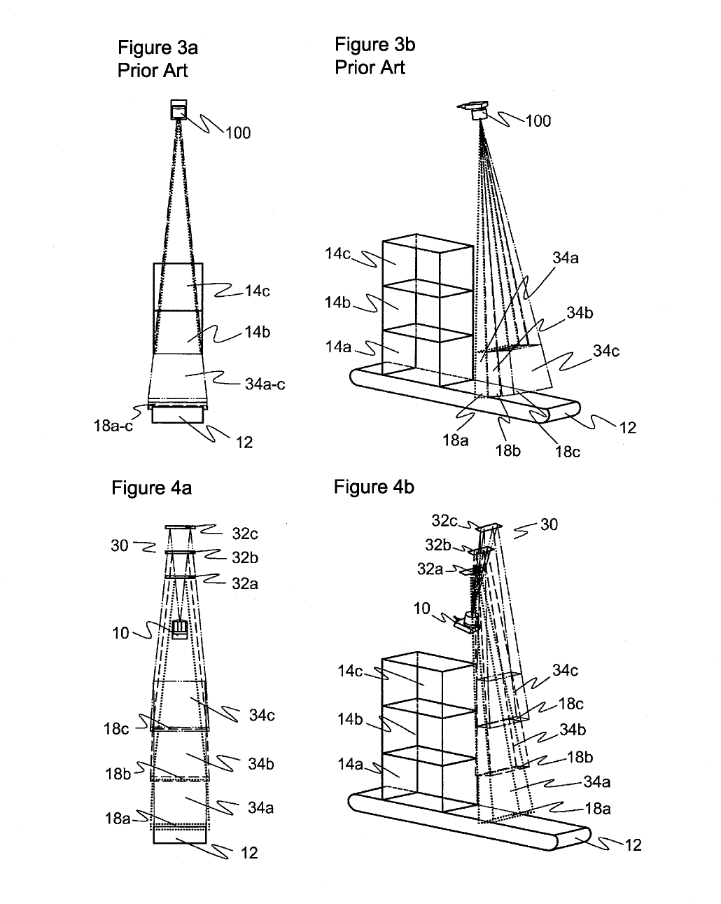

FIG. 3a a front view onto a common camera having a correlated reading range;

FIG. 3b a three-dimensional view of the camera in accordance with FIG. 3a;

FIG. 4a a front view onto an embodiment of a camera in accordance with the invention with a staggered segmented viewing field in a vertical arrangement;

FIG. 4b a three-dimensional view of the camera in accordance with FIG. 4a;

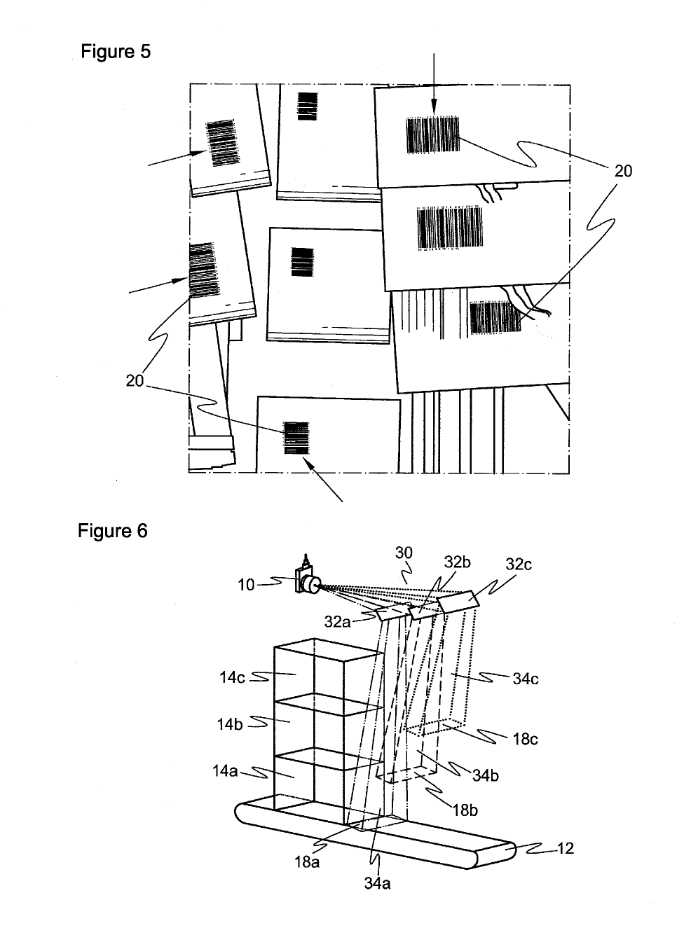

FIG. 5 an exemplary image of codes recorded a plurality of times in a plurality of sections;

FIG. 6 a three-dimensional view of a further embodiment of a camera in accordance with the invention with a staggered segmented viewing field in a horizontal arrangement; and

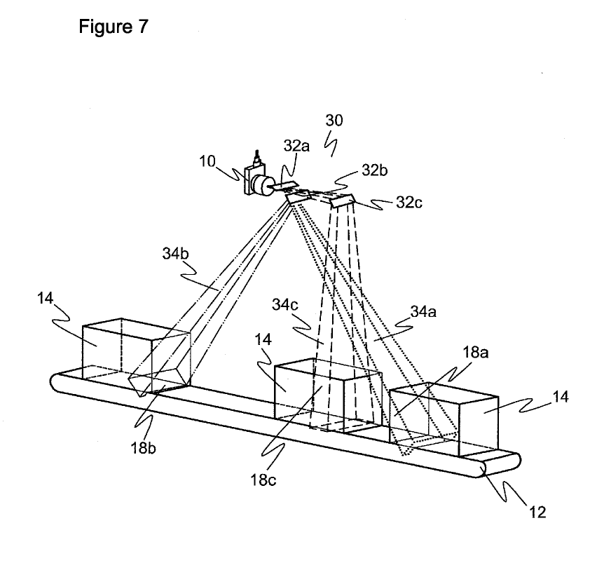

FIG. 7 a three-dimensional view of a further embodiment of a camera in accordance with the invention with an individualized segmented viewing field.

FIG. 1 shows a camera 10 configured as a code reader that is mounted above a conveyor belt 12 at which objects 14 are conveyed in a conveying direction 16 through a detection region 18 of the camera 10, the conveying direction being indicated by means of arrows. The objects 14 bear codes 20 at their outer surfaces, the codes being read by the camera 10. For this purpose the camera 10 takes images of the objects 14 respectively present in the detection region 18 with an image sensor 24 via a receiving optics 22, the image sensor having a plurality of light sensitive pixel elements arranged matrix-like or line-like. An evaluation unit 26 comprises a decoding unit which evaluates the images. In this respect code regions are identified and the code contents of the codes 20 are read out. The evaluation functionality can also be implemented at least partly outside of the camera 10.

The codes 20 can only then be recognized by the camera 10 when they are attached at the upper side or at least visible from above. For this reason a plurality of cameras 10 can be assembled from different directions in an illustration deviating from FIG. 1 for the reading of codes 20b attached, for example, laterally or from below in order to enable a so-called omni reading from all directions. The arrangement of the camera or the cameras 10 to a code reading system in practice frequently takes place as a reading tunnel. Further sensors can belong to the reading tunnel that are represented by a feed sensor 28 by way of example, for example, an incremental signal generator, by means of which the speed or the feed of the conveyor belt 12 can respectively be determined. Thereby information that was detected anywhere along the conveyor belt 12 can be transformed to a different position along the conveyor belt or to different points in time which due to the known feed is of equal importance. Further plausible sensors are a trigger light barrier which respectively recognizes the entrance of an object 14 into the detection region 18 or a geometry sensor, in particular a laser scanner which detects a 3D contour of the objects 14 at the conveyor belt 12.

The receiving optics 22 only has a limited depth of field range by means of which not all object heights are covered. For this reason a mirror unit having a plurality of mirror elements 32a-c is arranged in front of the camera 10. The mirror elements 34a-c respectively generate a viewing field segment 34a-c by means of which in turn respectively a section 18a-c of the detection region 18 at the conveyor belt 14 is detected. This is shown again in FIG. 2 in an enlarged manner and rotated by 90°. Due to the fact that the mirror elements 32a-c are arranged staggered in different heights and in this way with different spacings to the camera 10 different light paths result and in this way object spacings result. Thereby it is achieved that an object 14 of different height is detected in at least one section 18a-c within the depth of field range of the receiving optics 22. For this reason it is sufficient that the receiving optics 22 has a fixed focal length, although an additional focus adjustment should not necessarily be excluded.

Through the segmentation of the detection region 18 into sections 18a-c image segments also arise at the image sensor 24. The sections 18a-c are imaged stripwise above one another at the image sensor 24. An image sensor 24 as a matrix chip, for example, on the basis of CCD or CMOS technology, in any event has a side ratio that at least does not deviate too much from that of a quadratic shape. By means of typical recording frequencies and belt speeds of the conveyor belt 12, each code 20 is recorded for this reason a plurality of times such that also the more narrow image segments are sufficient to detect all codes. It is also plausible to increase the recording frequency, in particular by the number of mirror elements 32a-c in order to compensate the optical partitioning of the image sensor 24.

The illustrated number of three mirror elements 32a-c is to be understood as a particularly suitable example. The number is sufficient in order to cover typical object heights and at the same time segments of the image sensor 24 in not to stark a manner, such that a still sufficient width of the sections 18a-c remains. A mirror unit 30 having two or more than three mirror elements is however also possible.

In contrast to a pure focus adjustment that has to decide on an object height, also a plurality of objects 14 arranged next to one another of strongly varying object heights can be detected by means of the mirror unit 30. In one of the sections 18a-c the object spacing then matches this one object due to the staggered arrangement of mirror elements and in a different section 18a-c matches a different object 14. However, this also functions for an arbitrary number of objects. Merely as many mirror elements 32a-c have to be provided for a complete detection, such that the depth of field ranges complement one another without gaps.

A further advantage is that an optional active illumination of the camera 10, that is not illustrated in FIG. 1, can likewise be folded as a coaxial illumination with respect to the image sensor 24 by means of the mirror unit 30. In this way the sections 18a-c are illuminated in a targeted manner and in this respect with the correct focusing of a transmission optics of the illumination. In this way the optical power can be used in a substantially more targeted manner than for an alternatively possible illumination that has an as large as possible area and that is not guided by means of the mirror unit 30.

The recorded images can be processed in the evaluation unit 26 or in a down-stream image processing with parameters adapted to the sections 18a-c. Likewise parameters of the image sensor 24 or of the illumination can be set or regulated respectively in a section-wise manner. Thereby, for example, contrast or brightness can be adapted.

In a different illustration The FIGS. 3 and 4 again illustrate the expansion of the depth of field range by means of mirror segments 32a-c arranged at different spacings with respect to the camera 10. The resultant expanded depth of field range is in this respect distributed, as was already explained, proportionally by light paths of different length at the respective height levels.

FIG. 3 initially shows a common camera 100 without mirror elements 30 for the purpose of comparison. In this respect FIG. 3a is a front view and FIG. 3b is an associated three-dimensional view from the oblique front. Objects 14a-c of different heights are respectively shown that are to be detected. The camera 100 is set with its limited depth of field range to lower objects 14c. The segmentation in sections 18a-c is only drawn in for a better understanding. The sections 18a-c adjacent directly next to one another are naturally also imaged above one another at their image sensor having regard to common cameras 100. The light paths differ from one another however due to the lack of a mirror unit 30 not from section 18a-c to section 18a-c such that the sub-division is a purely artificial definition and cannot be recognized in the images of the camera 100.

Higher objects 14b-c lie outside of the limited depth of field range of the camera 100 and for this reason are not recorded in a focused manner. It would be plausible to compensate this by means of a focus adjustment. A focus adjustable receiving optics is, however, not only significantly more demanding in effort and cost than a receiving optics having a fixed focal length. Thereby two problems are not solved: on the one hand, the focus adjustment for objects 14a-c lying next to one another and of different height can only be set in a focused manner with respect to one of the objects 14a-c. Moreover, in FIG. 3a one sees that the high object 14c does not even lie completely in the viewing field of the camera 100. This limited reading field width is also not compensated by a focus adjustment.

FIG. 4 now shows the corresponding situation for an embodiment of a camera 10 in accordance with the invention. Through the mirror arrangement 30 with the exemplary three mirror elements 30a-c the reading region is folded and in this way an expanded depth of field range is obtained. Moreover, the reading width is homogeneously distributed over all object heights. The high object 14c is detected by means of the section 18c via the mirror element 30c spaced apart furthest, the central object 14b is detected by means of the section 18b via the middle mirror element 30b and the lowest object 14a is detected through the section 18a via the mirror element 30a arranged closest. One can also understand the sections 18a-c or the objects 14a-c of different height as an illustration of the depth of field ranges supplementing one another without gaps. Deviating therefrom a mutual overlap and also gaps within certain boundaries are plausible in which the images are then no longer detected with a full focus.

The mirror elements 32a-c amongst one another are preferably of equal size and equally spaced apart with respect to one another in order to maintain the assembly and the evaluation simple. One can also deviate from this. Moreover, the mirror elements 32a-c can be aligned in parallel with respect to one another or tilted with respect to one another. This leads to a corresponding shift of the sections 18a-c in the conveying direction 16 at the conveyor belt 12. Any displacement can be subtracted out due to the detected feed of the conveyor belt 12, for example, detected via the feed sensor 28. However, it is still possible to tilt the mirror elements 32a-c specifically with respect to one another in such a way that the sections 18a-c are not shifted in the conveying direction.

FIG. 5 shows an example image of codes 20 that were recorded with a camera 10 in accordance with the invention. It can clearly be seen that the codes 20 were detected three-times in strips lying above one another and with different image focus. Arrows indicate those recordings of the codes 20 that could be utilized for a successful decoding. This was successful for each code 20 at least once and for the left code 20 even twice, this means that the left code 20 was recorded at a height that still had a sufficient depth of field range in two sections 18a-c.

FIG. 6 shows a further embodiment of the camera 10 and the mirror unit 30 arranged there in front. In contrast to the embodiments discussed so far where the camera is oriented upwardly and the mirror elements 32a-c are staggered with different spacings upwardly the camera 10 is now oriented with its optical axis at least approximately in parallel to the conveying direction 16. Correspondingly the mirror elements 32a-c are horizontally staggered and are no longer oriented in parallel to the conveyor belt 12 for a 180° deflection, but rather are tilted by approximately 45° such that they fold the light path by approximately 90°. The detection region 18 is thereby totally shifted with respect to the camera 10 in the conveying direction. This arrangement is, for example, suitable in particular for height-limited installation situations.

FIG. 7 shows yet a different embodiment of the camera 10. Whereas so far the different light paths are primarily achieved by the spacings and only in a supplementary manner by means of the tilt angles of the mirror elements 32a-c, a significantly different tilting is selected in this example. Thereby the shift of the sections 18a-c is significantly larger than in the so far described embodiments. Like in the foregoing the arrangement can be used for the purpose of detecting objects 14a-c of different height in a focused manner. However, FIG. 7 also emphasizes that, through the mirror unit 30, a front reading, a top side reading and a rear side reading of the objects 14 can be achieved at the same time by means of a single camera 10 for which purpose so far at least two cameras with different recording positions and orientations were used. Therefrom it becomes clear that both the spacings as well as the tilt angles of the mirror elements 32a-c lead to an expanded viewing range individually or in combination with one another. Additional mirror elements 32a-c can still be used in order to enable a front side reading, a top side reading and a rear side reading respectively a multiple of times with light paths of different length and this way with an inherently already expanded depth of field range.

What is claimed is:

1. A camera for the detection of a flow of objects moved relative to the camera, comprising
an image sensor for taking images of the objects,
a receiving optics arranged in front of the image sensor, the receiving optics having a depth of field range, and
a mirror unit having at least two mirror elements, with the mirror unit being arranged in front of the receiving optics, the mirror elements having a different spacing amongst one another with respect to the receiving optics and/or having a different tilt angle and in this way imaging sections of the object flow a plurality of times with light paths of different length and in this way with different depth of field ranges at the image sensor.

2. The camera in accordance with claim 1,
that has a selection unit in order to respectively select an imaged section of largest image focus.

3. The camera in accordance with claim 1,
that is configured as a camera-based code reader having a decoding unit for the identification of code regions and for the readout of code content.

4. The camera in accordance with claim 1,
that has an illumination unit, whose light is deflected into the respective sections via the mirror elements in order to illuminate the sections.

5. The camera in accordance with claim 1,
wherein the mirror elements are arranged one after the other or staggered above one another.

6. The camera in accordance with claim 1,
wherein the mirror elements are tilted with respect to one another in such a way that they detect object surfaces of different orientation from two sections spaced part from one another.

7. The camera in accordance with claim 1,
wherein the mirror elements are divided into at least two mirror subsegments that are tilted with respect to one another in order to image part sections arranged lying next to one another in a width direction above one another at the image sensor.

8. The camera in accordance with claim 1, that is arranged in a stationary assembly at a conveying apparatus for objects provided with codes, with the objects forming the flow of objects.

9. The camera in accordance with claim 1,
in which the camera is oriented away from the moved flow.

10. The camera in accordance with claim 1,
in which the camera is oriented in parallel to the moved flow.

11. A method for the detection of a moved flow of objects, in which images of the objects are taken by a receiving optics having a depth of field range, the method comprising the step of
taking the images of the objects via a mirror unit having at least two mirror elements that have a different spacing amongst one another with respect to the receiving optics and/or having a different tilt angle and in this way imaging sections of the object flow a plurality of times with light paths of different length and in this way with different depth of field ranges.
